(19) United States
(12) Patent Application Publication
(10) Pub. No.: US 2022/0234185 A1
(43) Pub. Date: Jul. 28, 2022

(54) Noise Reduction Nailer And Speed Adjusting Assembly Thereof

(71) Applicants: Blue Point Fastening Inc., Chino Hills, CA (US); Yibin Heheng Technology Co., Ltd., Yibin City (CN)

(72) Inventors: Weidong ZHENG, Sichuan Province (CN); Wenhong DU, Sichuan Province (CN); Chao WANG, Yunnan Province (CN); Fangyi WANG, Chongqing (CN)

(21) Appl. No.: 17/585,185

(22) Filed: Jan. 26, 2022

(30) Foreign Application Priority Data
Jan. 27, 2021 (CN) 202120220354.2

(51) Int. Cl. B25C 1/08

(52) U.S. Cl. CPC B25C 1/08

(57) ABSTRACT

A noise reduction nailer and a speed adjusting assembly are described. The speed adjusting assembly may comprise a speed adjusting nut and a speed adjusting member matched with it. The speed adjusting member comprises a cover cap and a sear holder return spring fixed on the cover cap. Firing pins assembly with different heights are uniformly provided on a side wall of the sear holder return spring. The speed adjusting nut is composed of two speed adjusting rings with different diameters. A firing pin spring is provided on an inner side wall of the large-diameter speed adjusting ring and the large-diameter speed adjusting ring is adapted to the sear holder return spring. The speed adjusting assembly can adjust the shooting power of the nailer for different base bodies, and can use a steel ball to act on a small head cone of a pawl to automatically reset the pawl.

This application claims priority to China patent application no. 202120220354.2 filed on Jan. 27, 2021. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is fastening equipment, and specifically relates to a noise reduction nailer and a speed adjusting assembly thereof.

### BACKGROUND

The following description includes information that may be useful in understanding the present invention. It is not an admission that any of the information provided herein is prior art or relevant to the presently claimed invention, or that any publication specifically or implicitly referenced is prior art.

A nailer is a tool that uses a power source such as a nail firing bullet, nitrocellulose or gas to burn the gunpowder in the bullet as the power, wherein a pawl moves forward quickly to drive a nail into a base body such as steel and concrete for fastening.

Chinese Patent Application No. 201921268430.6 for utility model discloses a launch tube of a silent type nailer and the nailer. The nailer cannot adjust the movement speed of the pawl during use, resulting in a small range of use. Moreover, depending on the material of the base body, the power of the nail into the base body is different. If the power is too strong, the base body may be damaged; and if the power is too small, the nail may not be completely shot into the base body. Therefore, there is an urgent need for a nailer capable of performing power adjustment.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

In view of the shortcomings of the prior art, the inventive subject matter provides a noise reduction nailer and a speed adjusting assembly thereof, which can adjust the shooting power of the nailer for different base bodies, and at the same time, can use a steel ball to act on a small head cone of a pawl to automatically reset the pawl.

In order to achieve the above objective, the inventive subject matter is achieved by the following technical solution.

Disclosed in the inventive subject matter is a speed adjusting assembly of a nailer, comprising a speed adjusting nut and a speed adjusting member matched with it, wherein the speed adjusting member comprises a cover cap and a sear holder return spring fixed on the cover cap; firing pins assembly with different heights are uniformly provided on a side wall of the sear holder return spring; the speed adjusting nut is composed of two speed adjusting rings with different diameters; a firing pin spring is provided on an inner side wall of the large-diameter speed adjusting ring; and the large-diameter speed adjusting ring is adapted to the sear holder return spring.

Preferably, the firing pins assembly with different heights have the same thickness, and the firing pins assembly are divided into a first firing pins assembly with a height less than half of a height of the sear holder return spring, a second firing pins assembly with a height greater than half of the height of the sear holder return spring, and a third firing pins assembly with a height equal to the height of the sear holder return spring.

Preferably, the height of the large-diameter speed adjusting ring is equal to the height of the sear holder return spring.

Preferably, a thickness of the firing pins assembly is equal to a thickness of the firing pin spring, and the firing pin spring is along the firing pins assembly with different heights, so that the sear holder return spring is inserted into the large-diameter speed adjusting ring.

Preferably, an outer diameter of the cover cap is the same as an outer diameter of the small-diameter speed adjusting ring.

Correspondingly, a noise reduction nailer comprises a launch tube and a sear holder screwed to the launch tube, wherein a tool body opened toward the sear holder is provided in the launch tube; a liner with one end clamped with the tool body is provided in the sear holder; a pawl extending through the tool body into the liner is provided in the launch tube; the other end of the liner extends out of the sear holder and is screwed with a barrel; and the speed adjusting assembly is sleeved on the sear holder between the barrel and the launch tube.

Preferably, a piston is sleeved on the liner between the tool body and the sear holder; a piston return ring is provided on an inner wall of the launch tube; the tool body abuts on the piston return ring; and one end of the liner is a T-shaped head, and the tool body is adapted to the T-shaped head, so that one end of the liner is clamped in the tool body.

Preferably, the speed adjusting assembly comprises a speed adjusting nut and a speed adjusting member matched with it; the speed adjusting member comprises a cover cap and a sear holder return spring fixed on the cover cap; firing pins assembly with different heights are uniformly provided on a side wall of the sear holder return spring; the speed adjusting nut is composed of two speed adjusting rings with different diameters; a firing pin spring is provided on an inner side wall of the large-diameter speed adjusting ring; the large-diameter speed adjusting ring is adapted to the sear holder return spring; a piston return spring is provided on a side wall of the sear holder; the cover cap and the speed adjusting ring are separately sleeved on the sear holder; the piston return spring is clamped on a step surface where the cover cap and the sear holder return spring are connected; an end surface of the small-diameter speed adjusting ring is opposite to an end surface of the barrel; and the sear holder return spring corresponds to the large-diameter speed adjusting ring.

Preferably, a positioning ferrule assembly for positioning the sear holder is provided in a circumferential direction of the barrel; the positioning ferrule assembly comprises a through hole provided in the circumferential direction of the barrel; a fastener guide and a fastener guide cap are provided in the through hole in order from inside to outside; a power adjust nut is provided in the through hole and located above the fastener guide cap; and the fastener guide extends into the barrel and is located in an annular groove provided on a side wall of the sear holder.

Preferably, a limiting member for limiting the pawl is provided in the circumferential direction of the liner; the limiting member comprises a limiting hole provided in the circumferential direction of the liner; a front cap assembly is provided in the limiting hole; a handle grip is provided in the limiting hole and located above the front cap assembly; and the front cap assembly is partially located in the liner to limit the pawl.

The inventive subject matter described herein has the following beneficial effects:

1. In the inventive subject matter, the speed adjusting assembly is provided on the nailer, so as to realize the adjustment of the power of the nailer. Specifically, the speed control assembly comprises a speed adjusting nut and a speed adjusting member; the speed adjusting member comprises a cover cap and a sear holder return spring fixed on the cover cap; the speed adjusting nut is composed of two speed adjusting rings with different diameters; and a firing pin spring is provided on an inner side wall of the large-diameter speed adjusting ring. The firing pin spring can be clamped to the firing pins assembly with different heights to adjust the size of the space between the large-size end of the pawl and the air inlet of the launch tube to achieve power adjustment, thereby realizing the use of different powers to shoot on the base bodies with different materials, and avoiding the problem that the base body is damaged or the nail cannot be completely shot into the base body due to the shooting power being too large or too small.

2. The inventive subject matter combines the speed adjusting assembly and the noise reduction nailer, so that the nailer can not only adjust the shooting power during use, but also achieve noise reduction during use. That is, the inside of the launch tube is divided into cavities with different inner diameters, so that the high-pressure gas after the explosion enters the large-diameter section from the small-diameter section, so as to relieve the pressure and achieve the purpose of noise reduction. At the same time, in addition to the nailer disclosed in the inventive subject matter, the speed control assembly disclosed in the inventive subject matter can be applied to other types of nailers.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a structural schematic view of a speed adjusting nut.

FIG. 2 is a structural schematic view of a speed adjusting member.

FIG. 3 is a view of a state where a firing pin spring is clamped into a first firing pins assembly.

FIG. 4 is a view of a state where the firing pin spring is clamped into a second firing pins assembly.

FIG. 5 is a view of a state where the firing pin spring is clamped into a third firing pins assembly.

FIG. 6 is a structural schematic view where a speed adjusting assembly is assembled to a sear holder and the firing pin spring is clamped into the first firing pins assembly.

FIG. 7 is a structural schematic view where the speed adjusting assembly is assembled to the sear holder and the firing pin spring is clamped into the second firing pins assembly.

FIG. 8 is a structural schematic view where the speed adjusting assembly is assembled to the sear holder and the firing pin spring is clamped into the third firing pins assembly.

FIG. 9 is a view of a state of the speed control assembly after a nailer is fired in the state shown in FIG. 8.

FIG. 10 is a view of a state to be reset after firing on the basis of FIG. 9.

In the Figures: speed adjusting nut 1, cover cap 2, sear holder return spring 3, firing pin spring 4, first firing pins assembly 5, second firing pins assembly 6, third firing pins assembly 7, launch tube 8, sear holder 9, tool body 10, liner 11, pawl 12, barrel 13, piston 14, piston return ring 15, piston return spring 16, fastener guide 17, fastener guide cap 18, power adjust nut 19, front cap assembly 20, and handle grip 21.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The technical solutions in the embodiments of the inventive subject matter will be clearly and completely described below with reference to the accompanying drawings. Obviously, the described embodiments are only a part of the embodiments of the inventive subject matter, and not all the embodiments. On the basis of the embodiments described herein, all other embodiments obtained by an ordinary person skilled in the art without involving inventive skill belong to the scope of protection of the inventive subject matter.

Unless otherwise specified, the technical means used in the implementation examples are conventional means well known to the person skilled in the art.

The inventive subject matter was further developed on the basis of Chinese Patent Application No. 201921268430.6 for utility model at the initial stage of research and development. The inner cavity of the launch tube is divided into a first chamber, a second chamber, and a third chamber with different inner diameters, and a piston ring is provided in the circumferential direction of the large-size end of the pawl, so that the high-pressure gas generated by the high-temperature gunpowder is decompressed in the chambers with different inner diameters to achieve the purpose of noise reduction. However, the nailer disclosed in this patent cannot adjust the shooting power. Therefore, a speed adjusting assembly of a noise reduction nailer is disclosed in the inventive subject matter.

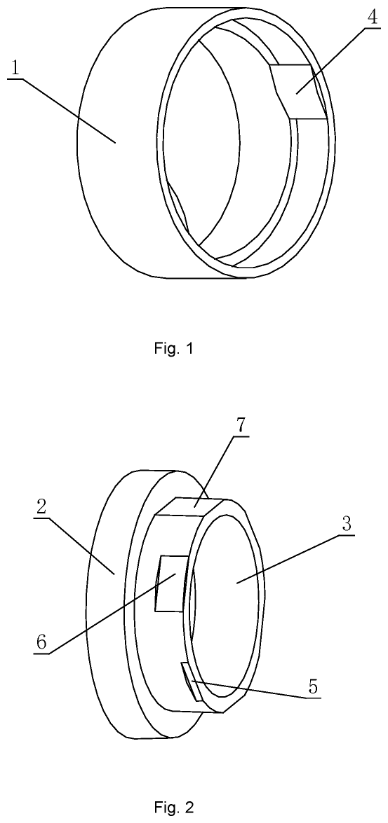

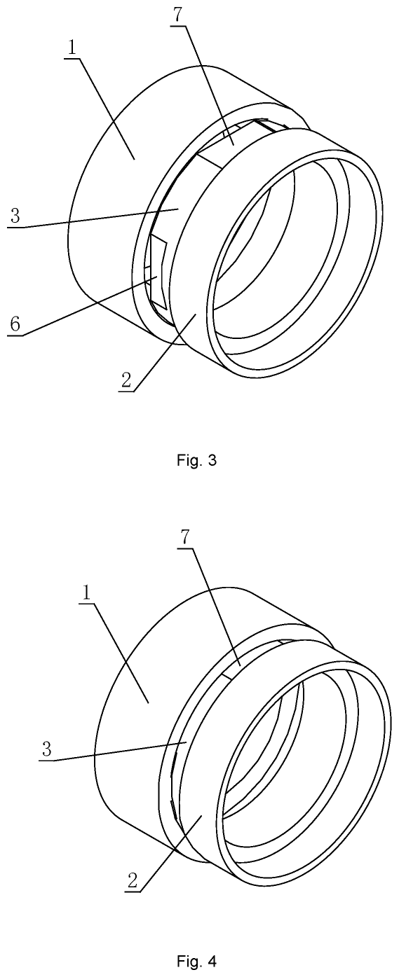

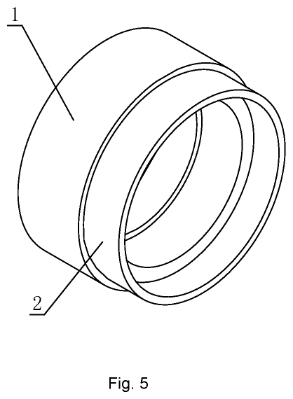

With reference to FIGS. 1 to 5, a speed adjusting assembly of a noise reduction nailer is disclosed in the inventive subject matter. The speed adjusting assembly comprises a speed adjusting nut 1 and a speed adjusting member matched with it. The speed adjusting member comprises a cover cap 2 and a sear holder return spring 3 fixed on the cover cap 2. The diameter of the cover cap 2 is larger than that of the sear holder return spring 3. Firing pins assembly with different heights are uniformly provided on the side wall of the sear holder return spring 3, and the firing pins assembly with different heights have the same thickness. Specifically, the firing pins assembly are divided into a first firing pins assembly 5 with a height less than half of a height of the sear holder return spring, a second firing pins assembly 6 with a height greater than half of the height of the sear holder return spring, and a third firing pins assembly 7 with a height equal to the height of the sear holder return spring. The speed adjusting nut 1 is composed of two speed adjusting rings with different diameters. A firing pin spring 4 is provided on the inner side wall of the large-diameter speed adjusting ring. The large-diameter speed adjusting ring is adapted to the sear holder return spring 3. The height of the large-diameter speed adjusting ring is equal to the height of the sear holder return spring 3. The thickness of the firing pins assembly is equal to the thickness of the firing pin spring 4, and the firing pin spring 4 is along the firing pins assembly of different heights, so that the sear holder return spring 3 is inserted into the large-diameter speed adjusting ring. The outer diameter of the cover cap 2 is the same as the outer diameter of the small-diameter speed adjusting ring. It should be noted that the firing pins assembly on the sear holder return spring 3 can be provided in multiple groups, taking the first firing pins assembly 5, the second firing pins assembly 6 and the third firing pins assembly 7 as one group. In this embodiment, two groups are preferably provided, and are provided symmetrically on the sear holder return spring 3. The number of protrusions 4 is preferably 1 or 2. In this embodiment, two firing pin springs are preferably provided, and are provided symmetrically. When the sear holder return spring 3 is inserted into the large-diameter speed adjusting ring, the firing pin springs 4 are placed in the firing pins assembly with different heights to realize the change of the length of the speed adjusting nut and the speed adjusting member. For details, please refer to FIGS. 3 to 5.

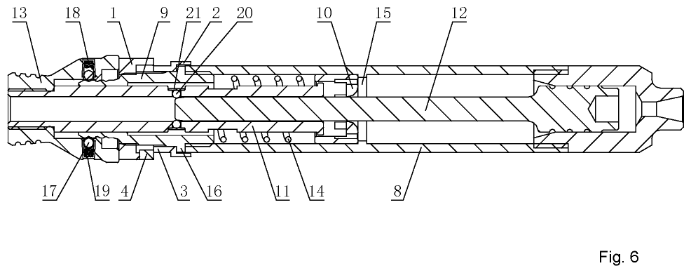

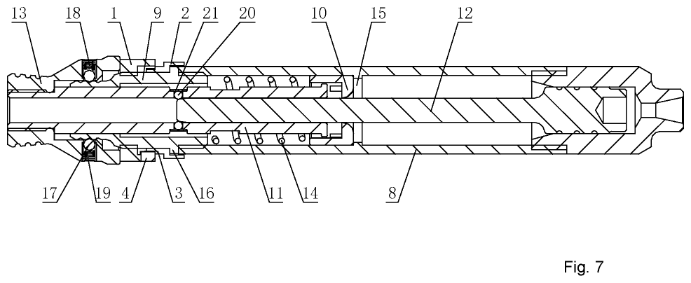

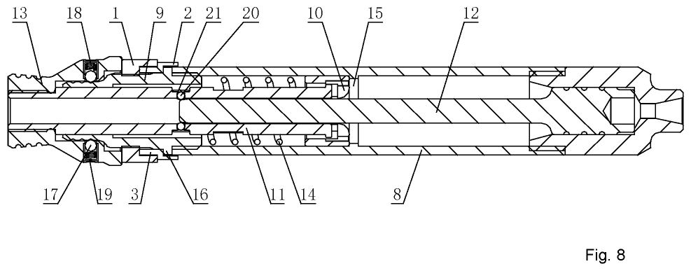

With reference to FIGS. 6 to 8, a launch assembly of a nailer is further disclosed in the inventive subject matter. The speed adjusting assembly disclosed above is installed on the launch assembly. Specifically, the launch assembly comprises a launch tube 8 and a sear holder 9 screwed to the launch tube 8. A piston return spring 16 is provided on the side wall of the sear holder 9. An external thread is provided on the side wall of the piston return spring 16 between it and an end surface of the sear holder 9 at one end, and an internal thread is provided on the inner wall of the launch tube 8, so that the launch tube 8 and the sear holder 9 are fixed by means of threads.

A piston return ring 15 is provided on the inner wall of the launch tube 8. A tool body 10 opened toward the sear holder 9 is provided in the launch tube 8 between the sear holder 9 and the piston return ring 15. The tool body 10 abuts against the piston return ring 15. A liner 11 with one end clamped with the tool body 10 is provided in the sear holder 9. That is, the cross section of one end of the liner 11 is a T-shaped head. The tool body 10 is adapted to the T-shaped head, so that one end of the liner 11 is clamped in the tool body 10 and can be along the length direction of the launch tube 8 in the cavity of the tool body 10. A piston 14 is sleeved on the liner 11 between the tool body 10 and the sear holder 9 so that the liner 11 returns to position after moving.

A pawl 12 extending through the tool body 10 into the liner 11 is provided in the launch tube 8. The side wall of one end of the pawl 12 has a certain taper, that is, the diameter gradually decreases from a position of the pawl 12 near the middle to the one end, and the other end is a large-size end. The large-size end faces an air inlet position of the launch tube 8. The inner diameter of the air inlet position of the launch tube 8 is smaller than the inner diameter of the tube body of the launch tube 8. The tapered end is limited by a limiting member provided in the circumferential direction of the liner 11. The limiting member comprises limiting holes provided in the circumferential direction of the liner 11. The limiting holes are located on the same plane. Preferably, there are two limiting holes, and they are symmetrically provided. A front cap assembly 20 is provided in the limiting hole, and a handle grip 21 is provided in the limiting hole and located above the front cap assembly 20. That is, the handle grip 21 is provided in the limiting hole near the outside of the hole, and the front cap assembly 20 is partially located in the liner 11 and abuts against the inclined surface of the side wall of the pawl 12, so as to limit the position of the pawl 12.

Further, the other end of the liner 11 extends out of the sear holder 9 and is screwed with a barrel 13. That is, an internal thread is provided on the inner wall of the barrel 13, and an external thread is provided on the outer side wall of the liner 11, so that the liner 11 is connected to the barrel 13 by means of threads. The liner 11 extends into the barrel 13, and its end is flush with an end opening of the barrel 13. A speed adjusting assembly is sleeved on the sear holder 9 between the barrel 13 and the launch tube 8. The speed control assembly comprises a speed adjusting nut 1 and a speed adjusting member matched with it. The speed adjusting member comprises a cover cap 2 and a sear holder return spring 3 fixed on the cover cap 2. Firing pins assembly with different heights are uniformly provided on the side wall of the sear holder return spring 3. The speed adjusting nut 1 is composed of two speed adjusting rings with different diameters. A firing pin spring 4 is provided on the inner side wall of the large-diameter speed adjusting ring, and the large-diameter speed adjusting ring is adapted to the sear holder return spring 3.

The cover cap 2 and the speed adjusting ring are separately sleeved on the sear holder 9. A piston return spring 16 is clamped on a step surface where the cover cap 2 and the sear holder return spring 3 are connected. An end surface of the small-diameter speed adjusting ring is opposite to an end surface of the barrel 13. The sear holder return spring 3 corresponds to the large-diameter speed adjusting ring. It should be noted that when the speed adjusting member and the speed adjusting nut are not fixed to the sear holder 9, both of them can be rotated on the sear holder 9. When the firing pin spring 4 needs to be inserted into the firing pins assembly with different heights, the power adjustment is realized. That is, the barrel 13 is twisted until the speed adjusting nut 1 can rotate relative to the speed adjusting member, so that the firing pin spring 4 on the speed adjusting nut 1 can be inserted into different firing pins assembly (the first firing pins assembly 5, the second firing pins assembly 6 or the third firing pins assembly 7). Of course, a thread may also be provided on the inner wall of the cover cap 2, so that its circumferential contact with the annular protrusion 16 is connected and fixed by means of threads, and then the speed adjusting nut 1 is rotated to achieve the purpose of adjusting the power. Alternatively, the connection between the small-diameter speed adjusting ring on the speed adjusting nut 1 and the side wall of the sear holder 9 is set to be connected and fixed by means of threads, and by rotating the speed adjusting member, the firing pin spring 4 corresponds to different firing pins assembly to achieve the purpose of adjusting the power. Therefore, the connection between the speed adjusting nut 1 and the speed adjusting member and the sear holder 9 is not unique, and the purpose of the present invention can be achieved by adopting the above three setting manners.

A positioning ferrule assembly for positioning the sear holder 9 is provided in the circumferential direction of the barrel 13, so as to prevent the barrel 13 from loosening. The positioning ferrule assembly comprises a through hole provided in the circumferential direction of the barrel 13. The through hole is on the same horizontal plane. A fastener guide 17 and a fastener guide cap 18 are provided in the through hole in order from the inside to the outside. A power adjust nut 19 is provided in the through hole and located above the fastener guide cap 18. The fastener guide 17 extends into the barrel 13 and is located in an annular groove provided on the side wall of the sear holder 9. It should be noted that several annular grooves are provided on the side wall of the sear holder 9 near its end, and the fastener guide 17 is partially located inside the barrel 13 and clamped into the annular grooves. The annular grooves can play a function of vortex air-sealing, and can help increase the explosive power of nail shooting bullets. The fastener guide cap 18 is pressed against the fastener guide 17. The power adjust nut 19 has a cylindrical shape with an open end and a hollow inside. The power adjust nut 19 is inserted into the through hole with the opening facing down, and is in interference fit with the through hole. The fastener guide cap 18 is placed in the power adjust nut 19, and the fastener guide 17 is subjected to the force of the fastener guide cap 18, so that the fastener guide 17 is pressed in the annular grooves, thereby clamping the barrel 13 and the sear holder 9 tightly.

In the inventive subject matter, views of states where the firing pin springs are in different firing pins assembly are shown in FIGS. 6 to 8, and also indicate the different powers of the nailer. The adjustment of different powers is also reflected in the distance/space between the large-sized end of the pawl 12 and the air inlet of the launch tube 8. The larger the space, the smaller the power; the smaller the space, the greater the power.

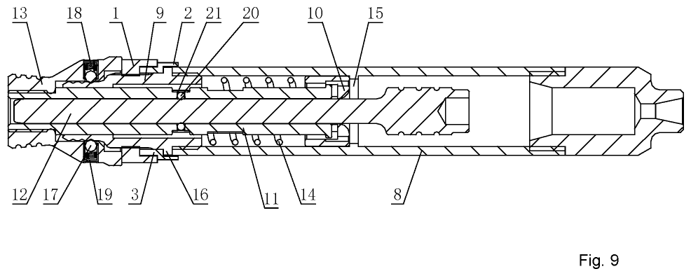

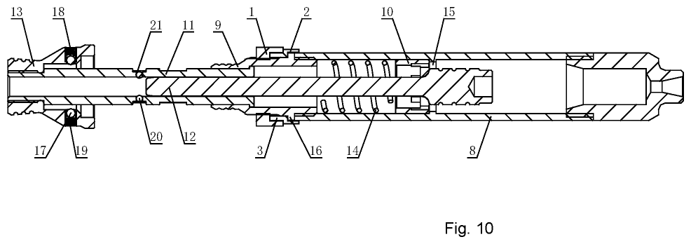

When in use, a nail is loaded in the liner 11, the liner 11 or the barrel 13 of the nailer is pressed onto a hard base body, and high-pressure gas generated after the nail shooting bullet explodes pushes the pawl 12 to move toward the base body. As shown in FIG. 9, in this process, the front cap assembly 20 gives way to make the pawl 12 hit the nail and stop at a position close to the exit end of the liner 11. The large-sized end of the pawl 12 is at the large diameter of the launch tube 8. The high-pressure gas generated by the explosion of the nail shooting bullet is released at the large diameter of the launch tube 8 to reduce the pressure, so as to achieve the purpose of noise reduction and complete a shot.

When it is ready for the next shooting, as shown in FIG. 10, the barrel 13 needs to be held by a hand and pulled to the left. The barrel 13 is separated from the sear holder 9, because the barrel 13 and the liner 11 are threadedly connected to the left end as an integral piece. Therefore, the liner 11 is driven to move to the left to the end, and the end surface of the sear holder 9 in the launch tube 8 faces the T-shaped head of the liner 11 for limiting. At the same time, if the pawl 12 is driven to move to the left, then the large-sized end of the pawl 12 is blocked by the tool body 10 to ensure that when the barrel 13 is pulled to the left in place, the front cap assembly 20 in the middle of the liner 11 separate from the pawl 12.

When the barrel 13 is held by the hand and moved to the right, the front cap assembly 20 in the middle of the liner 11 act on the tapered surface of the small-sized end of the pawl 12. A U-shaped handle grip 21 outside the front cap assembly 20 exerts pressure on the steel ball, forcing the steel ball to push the pawl 12 to the right, so as to return its large-sized end into the small-diameter section of the launch tube 8. When the right large-sized end surface of the pawl 12 abuts against the right end surface of the small-diameter section of the launch tube 8, the initial explosion space formed is the smallest. At this time, the nailer has the maximum power. When moving to the right, the inner hole of the tool body 10 supports the pawl 12 to ensure that the large-sized end of the pawl 12 enters the small diameter section of the launch tube 8 without too much deviation, which is advantageous to enter the small diameter.

The distance that the barrel 13 moves to the right is determined by the total length of the combination of the speed adjusting nut 1 and the speed adjusting member, and correspondingly determines the position where the front cap assembly 20 pushes the pawl 12 to move to the right, thereby adjusting the distance between the end surface of the large-sized end of the pawl 12 and the right end face of the small-diameter section of the launch tube 8, adjusting the initial volume of the nail shooting bullet when it explodes and achieving the purpose of adjusting the power (see FIGS. 6 to 8).

The speed adjusting assembly of the nailer disclosed in the inventive subject matter can adjust the shooting power of the nailer for different base bodies, but the number of depths of the processing planes varies, forming a corresponding number of multi-level power adjustments. Equivalently, one or two flat nuts may be used to rotate on the outer diameter of the sear holder 9. Limiting the barrel 13 can also achieve the purpose of adjusting the power, and the position of the rotating thread can adjust the shooting power at an infinite level, which also belongs to the scope of protection of the inventive subject matter.

If the base body is a soft base body, then the large-sized end of the pawl 12 will hit the tool body 10 and move toward the nail sleeve 9, playing a function of cushioning, and the piston 14 will be compressed. After the nail shooting operation is completed, the compressed reaction force of the piston 14 resets the tool body 10, and the handle grip 21 is subjected to the reaction force of the front cap assembly 20, so that the front cap assembly 20 falls back into the limiting hole again and partially extends into the liner 11 to make contact with the side wall of the pawl 12. At the same time, under the action of the slope of the side wall thereof and the rebound force of the pawl 12 after hitting the nail, it is reset and limited.

In the inventive subject matter, with reference to FIGS. 6 to 8, the diameter of the launch tube 8 is divided into two parts; one is a small-diameter section at the air inlet, and the other is a large-diameter section where the tool body 10 is located. The change of different volumes in the launch tube 8 achieves the purpose of decompressing the high-pressure gas entering the small-diameter section, and the decompressed high-pressure gas is ejected from the front end of the liner 11 to produce an explosion sound, which plays a function of noise reduction. It should be noted that: in the inventive subject matter, the diameter change of the launch tube 8 is divided into two sections. Of course, the diameter change of the launch tube 8 may be divided into multiple sections according to actual needs, for example, launch tubes shown in FIG. 1 and/or FIG. 4 of Chinese Patent Application No. 201921268430.6 for utility model. Specifically, the manner of changing the internal diameter of the launch tube in this patent is used, and other structures on the launch tube in this patent are not provided on the launch tube used in the inventive subject matter.

In the description of the inventive subject matter, it should be understood that the orientation or positional relationships indicated by the terms “longitudinal,” “transverse,” “upper,” “lower,” “front,” “rear,” “left,” “right,” “vertical,” “horizontal,” “top,” “bottom,” “inside,” “outside” and so on are based on the orientation or positional relationships shown in the relevant figures, which is merely for the convenience of describing the inventive subject matter, and does not indicate or imply that the mentioned device or element must have a particular orientation and be constructed and operated in the particular orientation. Therefore, the above terms cannot be construed as a limitation of the inventive subject matter.

The embodiments described above are only a description of preferred modes of the inventive subject matter, and are not intended to limit the scope of the inventive subject matter. Various modifications and improvements of the technical solution of the inventive subject matter made by an ordinary person skilled in the art without departing from the design spirit of the inventive subject matter should fall within the scope of protection determined by the claims of the inventive subject matter.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A speed adjusting assembly of a noise reduction nailer, comprising:
a speed adjusting nut and a speed adjusting member matched with the speed adjusting nut, wherein the speed adjusting member comprises a cover cap and a sear holder return spring fixed on the cover cap;
firing pins assembly with different heights are uniformly provided on a side wall of the sear holder return spring;
the speed adjusting nut comprises two speed adjusting rings with different diameters;
a firing pin spring is provided on an inner side wall of the large-diameter speed adjusting ring; and
the large-diameter speed adjusting ring is adapted to the sear holder return spring.

2. The speed adjusting assembly of claim 1, further comprising:
the firing pins assembly with different heights have the same thickness, and
the firing pins assembly are divided into a first firing pins assembly with a height less than half of a height of the sear holder return spring,
a second firing pins assembly with a height greater than half of the height of the sear holder return spring, and
a third firing pins assembly with a height equal to the height of the sear holder return spring.

3. The speed adjusting assembly of claim 1, wherein a height of the large-diameter speed adjusting ring is equal to a height of the sear holder return spring.

4. The speed adjusting assembly of claim 2, wherein a thickness of the firing pins assembly is equal to a thickness of the firing pin spring, and the firing pin spring is along the firing pins assembly with different heights, so that the sear holder return spring is inserted into the large-diameter speed adjusting ring.

5. The speed adjusting assembly of claim 1, wherein an outer diameter of the cover cap is the same as an outer diameter of the small-diameter speed adjusting ring.

6. A noise reduction nailer, comprising:
a launch tube and a sear holder screwed to the launch tube, comprising:
a tool body opened toward the sear holder is provided in the launch tube;
a liner with one end clamped with the tool body is provided in the sear holder;
a pawl extending through the tool body into the liner is provided in the launch tube;
the other end of the liner extends out of the sear holder and is screwed with a barrel; and
the speed adjusting assembly is sleeved on the sear holder between the barrel and the launch tube.

7. The noise reduction nailer of claim 6, further comprising:
a piston is sleeved on the liner between the tool body and the sear holder;
a piston return ring is provided on an inner wall of the launch tube;
the tool body abuts on the piston return ring; and one end of the liner is a T-shaped head, and the tool body is adapted to the T-shaped head, so that one end of the liner is clamped in the tool body.

8. The noise reduction nailer of claim 6, wherein the speed adjusting assembly comprises:
a speed adjusting nut and a speed adjusting member matched with it;
the speed adjusting member comprises a cover cap and a sear holder return spring fixed on the cover cap;
firing pins assembly with different heights are uniformly provided on a side wall of the sear holder return spring; the speed adjusting nut is composed of two speed adjusting rings with different diameters;
a firing pin spring is provided on an inner side wall of the large-diameter speed adjusting ring;
the large-diameter speed adjusting ring is adapted to the sear holder return spring;
a piston return spring is provided on a side wall of the sear holder;
the cover cap and the speed adjusting ring are separately sleeved on the sear holder;
the piston return spring is clamped on a step surface where the cover cap and the sear holder return spring are connected;
an end surface of the small-diameter speed adjusting ring is opposite to an end surface of the barrel; and
the sear holder return spring corresponds to the large-diameter speed adjusting ring.

9. The noise reduction nailer of claim 6, further comprising:
a positioning ferrule assembly for positioning the sear holder is provided in a circumferential direction of the barrel;
the positioning ferrule assembly comprises a through hole provided in the circumferential direction of the barrel;
a fastener guide and a fastener guide cap are provided in the through hole in order from inside to outside;
a power adjust nut is provided in the through hole and located above the fastener guide cap; and
the fastener guide extends into the barrel and is located in an annular groove provided on a side wall of the sear holder.

10. The noise reduction nailer of claim 6, further comprising:
a limiting member for limiting the pawl is provided in the circumferential direction of the liner;
the limiting member comprises a limiting hole provided in the circumferential direction of the liner;
a front cap assembly is provided in the limiting hole;
a handle grip is provided in the limiting hole and located above the front cap assembly; and
the front cap assembly is partially located in the liner to limit the pawl.
